(19) United States
(12) Patent Application Publication
(10) Pub. No.: US 2008/0024469 A1
(43) Pub. Date: Jan. 31, 2008

(54) Generating sub-frames for projection based on map values generated from at least one training image

(76) Inventors: Niranjan Damera-Venkata, Palo Alto, CA (US); Huitao Luo, Palo Alto, CA (US); Nelson Liang An Chang, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/496,358

(22) Filed: Jul. 31, 2006

(51) Int. Cl. G09G 5/00; H04N 9/31

(52) U.S. Cl. 345/204; 348/744

(57) ABSTRACT

A method of displaying an image with a display system includes generating a plurality of map values based on at least one training image. A first image frame is received. A plurality of sub-frames corresponding to the first image frame are generated based on a geometric relationship between a reference coordinate system and a plurality of projectors, and based on the plurality of map values. The plurality of sub-frames are projected onto a target surface with the plurality of projectors, thereby producing a resulting image on the target surface.

### CROSS-REFERENCE TO RELATED APPLICATION

This application is related to U.S. patent application Ser. No. 11/080,223, filed Mar. 15, 2005, and entitled PROJECTION OF OVERLAPPING SINGLE COLOR SUB-FRAMES ONTO A SURFACE and U.S. patent application Ser. No. 11/080,583, filed Mar. 15, 2005, and entitled PROJECTION OF OVERLAPPING SUB-FRAMES ONTO A SURFACE, both of which are hereby incorporated by reference herein.

### BACKGROUND

Two types of projection display systems are digital light processor (DLP) systems, and liquid crystal display (LCD) systems. It is desirable in some projection applications to provide a high lumen level output, but it is very costly to provide such output levels in existing DLP and LCD projection systems. Three choices exist for applications where high lumen levels are desired: (1) high-output projectors; (2) tiled, low-output projectors; and (3) superimposed, low-output projectors.

When information requirements are modest, a single high-output projector is typically employed. This approach dominates digital cinema today, and the images typically have a nice appearance. High-output projectors have the lowest lumen value (i.e., lumens per dollar). The lumen value of high output projectors is less than half of that found in low-end projectors. If the high output projector fails, the screen goes black. Also, parts and service are available for high output projectors only via a specialized niche market.

Tiled projection can deliver very high resolution, but it is difficult to hide the seams separating tiles, and output is often reduced to produce uniform tiles. Tiled projection can deliver the most pixels of information. For applications where large pixel counts are desired, such as command and control, tiled projection is a common choice. Registration, color, and brightness must be carefully controlled in tiled projection. Matching color and brightness is accomplished by attenuating output, which costs lumens. If a single projector fails in a tiled projection system, the composite image is ruined.

Superimposed projection provides excellent fault tolerance and full brightness utilization, but resolution is typically compromised. Algorithms that seek to enhance resolution by offsetting multiple projection elements have been previously proposed. These methods assume simple shift offsets between projectors, use frequency domain analyses, and rely on heuristic methods to compute component sub-frames. The proposed systems do not generate optimal sub-frames in real-time, and do not take into account arbitrary relative geometric distortion between the component projectors.

Existing projection systems do not provide a cost effective solution for high lumen level (e.g., greater than about 10,000 lumens) applications. In some existing projection systems, each projector needs to know what all of the other projectors in the system are projecting in order to compute its own optimal image to project, and memory is shared by multiple projectors. Image generation algorithms for the projectors are typically iterative, and multiple iterations are typically used to produce optimal image quality. The image generation algorithms also do not typically incorporate more sophisticated techniques, such as luminance correction, regularization, and supersampling, since these techniques are typically computationally complex and can be time consuming. The image generation algorithms also cannot typically be scaled up gracefully as projectors are added to the system.

### SUMMARY

One form of the present invention provides a method of displaying an image with a display system. The method includes generating a plurality of map values based on at least one training image. A first image frame is received. A plurality of sub-frames corresponding to the first image frame are generated based on a geometric relationship between a reference coordinate system and a plurality of projectors, and based on the plurality of map values. The plurality of sub-frames are projected onto a target surface with the plurality of projectors, thereby producing a resulting image on the target surface.

### BRIEF DESCRIPTION OF THE DRAWINGS

FIG. 1 is a block diagram illustrating an image display system according to one embodiment of the present invention.

FIGS. 2A-2C are schematic diagrams illustrating the projection of two sub-frames according to one embodiment of the present invention.

FIG. 3 is a diagram illustrating a model of an image formation process according to one embodiment of the present invention.

FIG. 4 is a diagram illustrating the two phases of the sub-frame generation process according to one embodiment of the present invention.

FIG. 5 is a flow diagram illustrating a method for generating sub-frame generation maps during a training phase of the multi-projector system shown in FIG. 1 according to one embodiment of the present invention.

FIG. 6A is a diagram illustrating the projection of a pixel center performed in the method shown in FIG. 5 according to one embodiment of the present invention.

FIG. 6B is a diagram illustrating the projection of a pixel center performed in the method shown in FIG. 5 using impulse training images according to one embodiment of the present invention.

FIG. 7 is a flow diagram illustrating a method for generating low-resolution sub-frames from high-resolution frames during normal operation of the system shown in FIG. 1 according to one embodiment of the present invention.

FIG. 8 is a diagram illustrating the projection of a pixel center performed in the method shown in FIG. 7 according to one embodiment of the present invention.

FIG. 9 is a flow diagram illustrating a method of displaying an image with the display system shown FIG. 1 according to one embodiment of the present invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” etc., may be used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

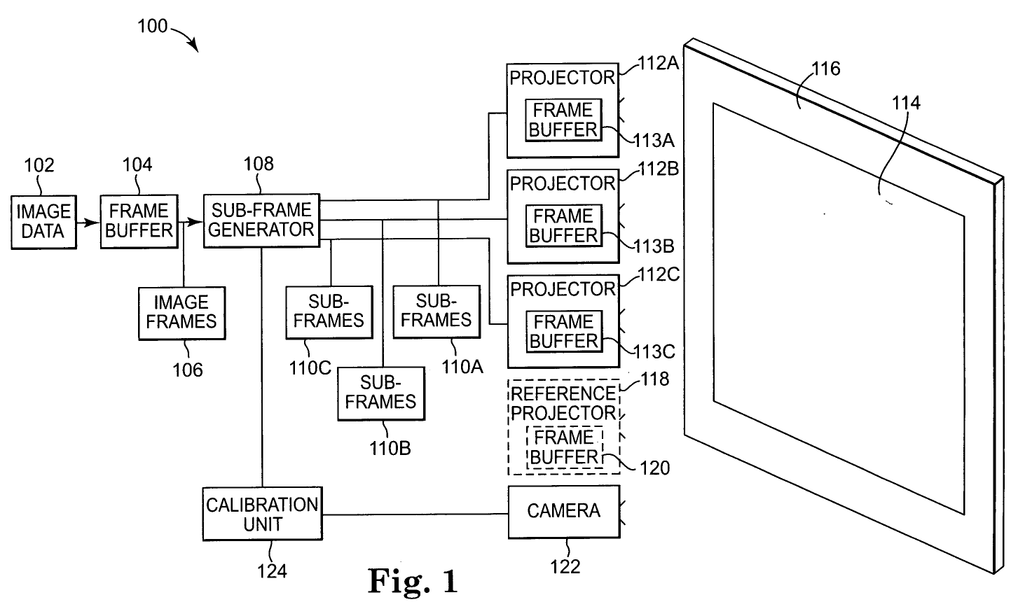

FIG. 1 is a block diagram illustrating an image display system 100 according to one embodiment of the present invention. Image display system 100 processes image data 102 and generates a corresponding displayed image 114. Displayed image 114 is defined to include any pictorial, graphical, or textural characters, symbols, illustrations, or other representations of information.

In one embodiment, image display system 100 includes image frame buffer 104, sub-frame generator 108, projectors 112A-112C (collectively referred to as projectors 112), camera 122, and calibration unit 124. Image frame buffer 104 receives and buffers image data 102 to create image frames 106. Sub-frame generator 108 processes image frames 106 to define corresponding image sub-frames 110A-110C (collectively referred to as sub-frames 110). In one embodiment, for each image frame 106, sub-frame generator 108 generates one sub-frame 110A for projector 112A, one sub-frame 110B for projector 112B, and one sub-frame 110C for projector 112C. The sub-frames 110A-110C are received by projectors 112A-112C, respectively, and stored in image frame buffers 113A-113C (collectively referred to as image frame buffers 113), respectively. Projectors 112A-112C project the sub-frames 110A-110C, respectively, onto target surface 116 to produce displayed image 114 for viewing by a user.

Image frame buffer 104 includes memory for storing image data 102 for one or more image frames 106. Thus, image frame buffer 104 constitutes a database of one or more image frames 106. Image frame buffers 113 also include memory for storing sub-frames 110. Examples of image frame buffers 104 and 113 include non-volatile memory (e.g., a hard disk drive or other persistent storage device) and may include volatile memory (e.g., random access memory (RAM)).

Sub-frame generator 108 receives and processes image frames 106 to define a plurality of image sub-frames 110. Sub-frame generator 108 generates sub-frames 110 based on image data in image frames 106. In one embodiment, sub-frame generator 108 generates image sub-frames 110 with a resolution that matches the resolution of projectors 112, which is less than the resolution of image frames 106 in one embodiment. Sub-frames 110 each include a plurality of columns and a plurality of rows of individual pixels representing a subset of an image frame 106.

Projectors 112 receive image sub-frames 110 from sub-frame generator 108 and, in one embodiment, simultaneously project the image sub-frames 110 onto target surface 116 at overlapping and spatially offset positions to produce displayed image 114. In one embodiment, display system 100 is configured to give the appearance to the human eye of high-resolution displayed images 114 by displaying overlapping and spatially shifted lower-resolution sub-frames 110 from multiple projectors 112. In one form of the invention, the projection of overlapping and spatially shifted sub-frames 110 gives the appearance of enhanced resolution (i.e., higher resolution than the sub-frames 110 themselves).

A problem of sub-frame generation, which is addressed by embodiments of the present invention, is to determine appropriate values for the sub-frames 110 so that the resulting displayed image 114 produced by the projected sub-frames 110 is close in appearance to how the high-resolution image (e.g., image frame 106) from which the sub-frames 110 were derived would appear if displayed directly.

It will be understood by a person of ordinary skill in the art that functions performed by sub-frame generator 108 may be implemented in hardware, software, firmware, or any combination thereof. The implementation may be via a microprocessor, programmable logic device, or state machine. Components of the present invention may reside in software on one or more computer-readable mediums. The term computer-readable medium as used herein is defined to include any kind of memory, volatile or non-volatile, such as floppy disks, hard disks, CD-ROMs, flash memory, read-only memory, and random access memory.

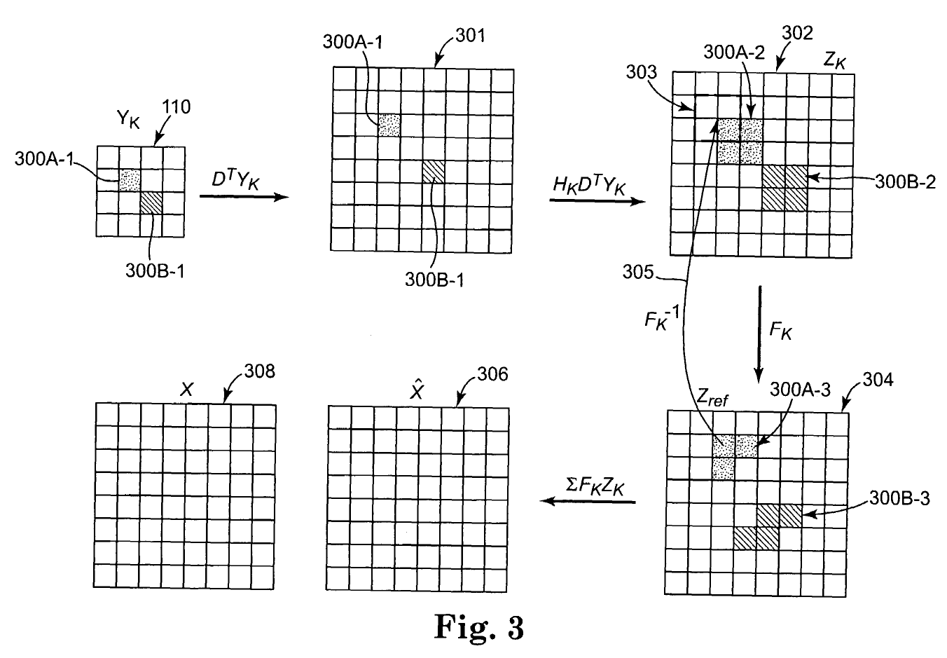

Also shown in FIG. 1 is reference projector 118 with an image frame buffer 120. Reference projector 118 is shown with hidden lines in FIG. 1 because, in one embodiment, projector 118 is not an actual projector, but rather is a hypothetical high-resolution reference projector that is used in an image formation model for generating optimal sub-frames 110, as described in further detail below with reference to FIG. 3. In one embodiment, the location of one of the actual projectors 112 is defined to be the location of the reference projector 118.

In one embodiment, display system 100 includes a camera 122 and a calibration unit 124, which are used in one form of the invention to automatically determine a geometric mapping between each projector 112 and the reference projector 118, as described in further detail below with reference to FIG. 3.

In one form of the invention, image display system 100 includes hardware, software, firmware, or a combination of these. In one embodiment, one or more components of image display system 100 are included in a computer, computer server, or other microprocessor-based system capable of performing a sequence of logic operations. In addition, processing can be distributed throughout the system with individual portions being implemented in separate system components, such as in a networked or multiple computing unit environment.

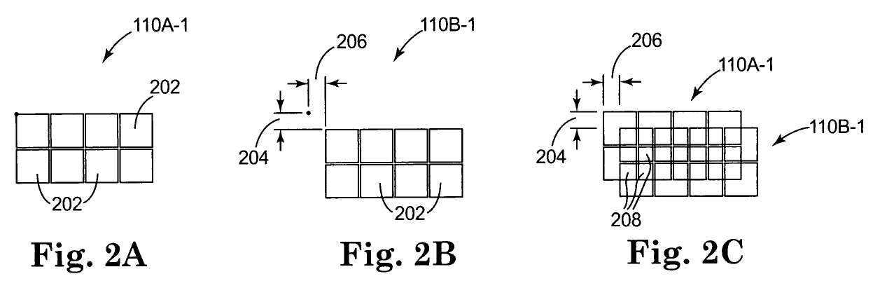

In one embodiment, display system 100 uses two projectors 112. FIGS. 2A-2C are schematic diagrams illustrating the projection of two sub-frames 110 according to one embodiment of the present invention. As illustrated in FIGS. 2A and 2B, sub-frame generator 108 defines two image sub-frames 110 for each of the image frames 106. More specifically, sub-frame generator 108 defines a first sub-frame 110A-1 and a second sub-frame 110B-1 for an image frame 106. As such, first sub-frame 110A-1 and second sub-frame 110B-1 each include a plurality of columns and a plurality of rows of individual pixels 202 of image data.

In one embodiment, as illustrated in FIG. 2B, when projected onto target 116, second sub-frame 110B-1 is offset from first sub-frame 110A-1 by a vertical distance 204 and a horizontal distance 206. As such, second sub-frame 110B-1 is spatially offset from first sub-frame 110A-1 by a predetermined distance. In one illustrative embodiment, vertical distance 204 and horizontal distance 206 are each approximately one-half of one pixel.

As illustrated in FIG. 2C, a first one of the projectors 112A projects first sub-frame 110A-1 in a first position and a second one of the projectors 112B projects second sub-frame 110B-1 in a second position, spatially offset from the first position. More specifically, the display of second sub-frame 110B-1 is spatially shifted relative to the display of first sub-frame 110A-1 by vertical distance 204 and horizontal distance 206. As such, pixels of first sub-frame 110A-1 overlap pixels of second sub-frame 110B-1, thereby producing the appearance of higher resolution pixels 208. The overlapped sub-frames 110A-1 and 110B-1 also produce a brighter overall image 114 than either of the sub-frames 110 alone. In other embodiments, more than two projectors 112 are used in system 100, and more than two sub-frames 110 are defined for each image frame 106, which results in a further increase in the resolution and brightness of the displayed image 114.

It will be understood by persons of ordinary skill in the art that the sub-frames 110 projected onto target 116 may have perspective distortions, and the pixels may not appear as perfect squares with no variation in the offsets and overlaps from pixel to pixel, such as that shown in FIGS. 2A-2C. Rather, in one form of the invention, the pixels of sub-frames 110 take the form of distorted quadrilaterals or other some other shape, and the overlaps may vary as a function of position. Thus, terms such as “spatially shifted” and “spatially offset positions” as used herein are not limited to a particular pixel shape or fixed offsets and overlaps from pixel to pixel, but rather are intended to include any arbitrary pixel shape, and offsets and overlaps that may vary from pixel to pixel.

In one form of the invention, sub-frames 110 have a lower resolution than image frames 106. Thus, sub-frames 110 are also referred to herein as low-resolution images or sub-frames 110, and image frames 106 are also referred to herein as high-resolution images or frames 106. It will be understood by persons of ordinary skill in the art that the terms low resolution and high resolution are used herein in a comparative fashion, and are not limited to any particular minimum or maximum number of pixels.

In one form of the invention, display system 100 produces a superimposed projected output that takes advantage of natural pixel mis-registration to provide a displayed image 114 with a higher resolution than the individual sub-frames 110. In one embodiment, image formation due to multiple overlapped projectors 112 is modeled using a signal processing model. Optimal sub-frames 110 for each of the component projectors 112 are estimated by sub-frame generator 108 based on the model, such that the resulting image predicted by the signal processing model is as close as possible to the desired high-resolution image to be projected.

In one embodiment, sub-frame generator 108 is configured to generate sub-frames 110 based on the maximization of a probability that, given a desired high resolution image, a simulated high-resolution image that is a function of the sub-frame values, is the same as the given, desired high-resolution image. If the generated sub-frames 110 are optimal, the simulated high-resolution image will be as close as possible to the desired high-resolution image. The generation of optimal sub-frames 110 based on a simulated high-resolution image and a desired high-resolution image is described in further detail below with reference to FIG. 3.

FIG. 3 is a diagram illustrating a model of an image formation process according to one embodiment of the present invention. The sub-frames 110 are represented in the model by Yₖ, where “k” is an index for identifying the individual projectors 112. Thus, Y₁, for example, corresponds to a sub-frame 110A for a first projector 112A, Y₂ corresponds to a sub-frame 110B for a second projector 112B, etc. Two of the sixteen pixels of the sub-frame 110 shown in FIG. 3 are highlighted, and identified by reference numbers 300A-1 and 300B-1. The sub-frames 110 (Yₖ) are represented on a hypothetical high-resolution grid by up-sampling (represented by D^{T}) to create up-sampled image 301. The up-sampled image 301 is filtered with an interpolating filter (represented by Hₖ) to create a high-resolution image 302 (Zₖ) with “chunky pixels”. This relationship is expressed in the following Equation I:

Zₖ=HₖD^{T}Yₖ Equation I

where:
k=index for identifying the projectors 112;
Zₖ=low-resolution sub-frame 110 of the kth projector 112 on a hypothetical high-resolution grid;
Hₖ=Interpolating filter for low-resolution sub-frame 110 from kth projector 112;
D^{T}=up-sampling matrix; and
Yₖ=low-resolution sub-frame 110 of the kth projector 112.

The low-resolution sub-frame pixel data (Yₖ) is expanded with the up-sampling matrix (D^{T}) so that the sub-frames 110 (Yₖ) can be represented on a high-resolution grid. The interpolating filter (Hₖ) fills in the missing pixel data produced by up-sampling. In the embodiment shown in FIG. 3, pixel 300A-1 from the original sub-frame 110 (Yₖ) corresponds to four pixels 300A-2 in the high-resolution image 302 (Zₖ), and pixel 300B-1 from the original sub-frame 110 (Yₖ) corresponds to four pixels 300B-2 in the high-resolution image 302 (Zₖ). The resulting image 302 (Zₖ) in Equation I models the output of the k^{th} projector 112 if there was no relative distortion or noise in the projection process. Relative geometric distortion between the projected component sub-frames 110 results due to the different optical paths and locations of the component projectors 112. A geometric transformation is modeled with the operator, Fₖ, which maps coordinates in the frame buffer 113 of the k^{th} projector 112 to a reference coordinate system, such as the frame buffer 120 of the reference projector 118 (FIG. 1), with sub-pixel accuracy, to generate a warped image 304 (Z_{ref}). In one form of the invention, the transformation, Fₖ, is a coordinate mapping such as a translational shift, affine transformation, projective warp, or a more general non-linear transformation.

In one embodiment, Fₖ is linear with respect to pixel intensities, but is non-linear with respect to the coordinate transformations. As shown in FIG. 3, the four pixels 300A-2 in image 302 are mapped to the three pixels 300A-3 in image 304, and the four pixels 300B-2 in image 302 are mapped to the four pixels 300B-3 in image 304.

In one embodiment, the geometric mapping (Fₖ) is a floating-point mapping, but the destinations in the mapping are on an integer grid in image 304. Thus, it is possible for multiple pixels in image 302 to be mapped to the same pixel location in image 304, resulting in missing pixels in image 304. To avoid this situation, in one form of the present invention, during the forward mapping (Fₖ), the inverse mapping (Fₖ⁻¹) is also utilized as indicated at 305 in FIG. 3. Each destination pixel in image 304 is back projected (i.e., Fₖ⁻¹) to find the corresponding location in image 302. For the embodiment shown in FIG. 3, the location in image 302 corresponding to the upper-left pixel of the pixels 300A-3 in image 304 is the location at the upper-left corner of the group of pixels 300A-2. In one form of the invention, the values for the pixels neighboring the identified location in image 302 are combined (e.g., averaged) to form the value for the corresponding pixel in image 304. Thus, for the example shown in FIG. 3, the value for the upper-left pixel in the group of pixels 300A-3 in image 304 is determined by averaging the values for the four pixels within the frame 303 in image 302.

In another embodiment of the invention, the forward geometric mapping or warp (Fₖ) is implemented directly, and the inverse mapping (Fₖ⁻¹) is not used. In one form of this embodiment, a scatter operation is performed to eliminate missing pixels. That is, when a pixel in image 302 is mapped to a floating point location in image 304, some of the image data for the pixel is essentially scattered to multiple pixels neighboring the floating point location in image 304. Thus, each pixel in image 304 may receive contributions from multiple pixels in image 302, and each pixel in image 304 is normalized based on the number of contributions it receives.

A superposition/summation of such warped images 304 from all of the component projectors 112 forms a hypothetical or simulated high-resolution image 306 (X-hat) in the reference projector frame buffer 120, as represented in the following Equation II:

$$\hat{X} = {\sum }_{k} {F}_{k} {Z}_{k} \qquad Equation II$$

where:
k=index for identifying the projectors 112;
X-hat=hypothetical or simulated high-resolution image 306 in the reference projector frame buffer 120;
Fₖ=operator that maps a low-resolution sub-frame 110 of the kth projector 112 on a hypothetical high-resolution grid to the reference projector frame buffer 120; and
Zₖ=low-resolution sub-frame 110 of kth projector 112 on a hypothetical high-resolution grid, as defined in Equation I.

If the simulated high-resolution image 306 (X-hat) in the reference projector frame buffer 120 is identical to a given (desired) high-resolution image 308 (X), the system of component low-resolution projectors 112 would be equivalent to a hypothetical high-resolution projector placed at the same location as the reference projector 118 and sharing its optical path. In one embodiment, the desired high-resolution images 308 are the high-resolution image frames 106 (FIG. 1) received by sub-frame generator 108.

In one embodiment, the deviation of the simulated high-resolution image 306 (X-hat) from the desired high-resolution image 308 (X) is modeled as shown in the following Equation III:

X=\hat{X}+η Equation III

where:
X=desired high-resolution frame 308;
X-hat=hypothetical or simulated high-resolution frame 306 in the reference projector frame buffer 120; and
η=error or noise term.

As shown in Equation III, the desired high-resolution image 308 (X) is defined as the simulated high-resolution image 306 (X-hat) plus η, which in one embodiment represents zero mean white Gaussian noise.

The solution for the optimal sub-frame data (Yₖ*) for the sub-frames 110 is formulated as the optimization given in the following Equation IV:

$${Y}_{k}^{*} = {argmax}_{{Y}_{k}} P ( \hat{X} \vert X ) \qquad Equation IV$$

where:
k=index for identifying the projectors 112;
Yₖ*=optimum low-resolution sub-frame 110 of the kth projector 112;
Yₖ=low-resolution sub-frame 110 of the kth projector 112;
X-hat=hypothetical or simulated high-resolution frame 306 in the reference projector frame buffer 120, as defined in Equation II;
X=desired high-resolution frame 308; and
P(X-hat|X)=probability of X-hat given X.

Thus, as indicated by Equation IV, the goal of the optimization is to determine the sub-frame values (Yₖ) that maximize the probability of X-hat given X. Given a desired high-resolution image 308 (X) to be projected, sub-frame generator 108 (FIG. 1) determines the component sub-frames 110 that maximize the probability that the simulated high-resolution image 306 (X-hat) is the same as or matches the “true” high-resolution image 308 (X).

Using Bayes rule, the probability P(X-hat|X) in Equation IV can be written as shown in the following Equation V:

$$P ( \hat{X} \vert X ) = \frac{P ( X \vert \hat{X} ) P ( \hat{X} )}{P ( X )} \qquad Equation V$$

where:
X-hat=hypothetical or simulated high-resolution frame 306 in the reference projector frame buffer 120, as defined in Equation II;
X=desired high-resolution frame 308;
P(X-hat|X)=probability of X-hat given X;
P(X|X-hat)=probability of X given X-hat;
P(X-hat)=prior probability of X-hat; and
P(X)=prior probability of X.

The term P(X) in Equation V is a known constant. If X-hat is given, then, referring to Equation III, X depends only on the noise term, η, which is Gaussian. Thus, the term P(X|X-hat) in Equation V will have a Gaussian form as shown in the following Equation VI:

$$P ( X \vert \hat{X} ) = \frac{1}{C} {e}^{- \frac{{‖ X - \hat{X} ‖}^{2}}{2 {σ}^{2}}} \qquad Equation VI$$

where:
X-hat=hypothetical or simulated high-resolution frame 306 in the reference projector frame buffer 120, as defined in Equation II;
X=desired high-resolution frame 308;
P(X|X-hat)=probability of X given X-hat;
C=normalization constant; and
σ=variance of the noise term, η.

To provide a solution that is robust to minor calibration errors and noise, a “smoothness” requirement is imposed on X-hat. In other words, it is assumed that good simulated images 306 have certain properties. The smoothness requirement according to one embodiment is expressed in terms of a desired Gaussian prior probability distribution for X-hat given by the following Equation VII:

$$P ( \hat{X} ) = \frac{1}{Z ( β )} {e}^{- \{ {β}^{2} ( {‖ ∇ \hat{X} ‖}^{2} ) \}} \qquad Equation VII$$

where:
P(X-hat)=prior probability of X-hat;
β=smoothing constant;
Z(β)=normalization function;
∇=gradient operator; and
X-hat=hypothetical or simulated high-resolution frame 306 in the reference projector frame buffer 120, as defined in Equation II.

In another embodiment of the invention, the smoothness requirement is based on a prior Laplacian model, and is expressed in terms of a probability distribution for X-hat given by the following Equation VIII:

$$P ( \hat{X} ) = \frac{1}{Z ( β )} {e}^{- \{ β ( ‖ ∇ \hat{X} ‖ ) \}} \qquad Equation VIII$$

where:
P(X-hat)=prior probability of X-hat;
β=smoothing constant;
Z(β)=normalization function;
∇=gradient operator; and
X-hat=hypothetical or simulated high-resolution frame 306 in the reference projector frame buffer 120, as defined in Equation II.

The following discussion assumes that the probability distribution given in Equation VII, rather than Equation VIII, is being used. As will be understood by persons of ordinary skill in the art, a similar procedure would be followed if Equation VIII were used. Inserting the probability distributions from Equations VI and VII into Equation V, and inserting the result into Equation IV, results in a maximization problem involving the product of two probability distributions (note that the probability P(X) is a known constant and goes away in the calculation). By taking the negative logarithm, the exponents go away, the product of the two probability distributions becomes a sum of two probability distributions, and the maximization problem given in Equation IV is transformed into a function minimization problem, as shown in the following Equation IX:

$${Y}_{k}^{*} = {argmin}_{{Y}_{k}} {‖ X - \hat{X} ‖}^{2} + {β}^{2} {‖ ∇ \hat{X} ‖}^{2} \qquad Equation IX$$

where:
k=index for identifying the projectors 112;
Yₖ*=optimum low-resolution sub-frame 110 of the kth projector 112;
Yₖ=low-resolution sub-frame 110 of the kth projector 112;
X-hat=hypothetical or simulated high-resolution frame 306 in the reference projector frame buffer 120, as defined in Equation II;
X=desired high-resolution frame 308;
β=smoothing constant; and
∇=gradient operator.

The function minimization problem given in Equation IX is solved by substituting the definition of X-hat from Equation II into Equation IX and taking the derivative with respect to Yₖ, which results in an iterative algorithm given by the following Equation X:

Yₖ⁽ⁿ⁺¹⁾=Yₖ⁽ⁿ⁾−Θ{DHₖ^{T}Fₖ^{T}└(\hat{X}⁽ⁿ⁾−X)+β²∇²\hat{X}⁽ⁿ⁾┘} Equation X

where:
k=index for identifying the projectors 112;
n=index for identifying iterations;
Yₖ⁽ⁿ⁺¹⁾=low-resolution sub-frame 110 for the kth projector 112 for iteration number n+1;
Yₖ⁽ⁿ⁾=low-resolution sub-frame 110 for the kth projector 112 for iteration number n;
Θ=momentum parameter indicating the fraction of error to be incorporated at each iteration;
D=down-sampling matrix;
Hₖ^{T}=Transpose of interpolating filter, Hₖ, from Equation I (in the image domain, Hₖ^{T} is a flipped version of Hₖ);
Fₖ^{T}=Transpose of operator, Fₖ, from Equation II (in the image domain, Fₖ^{T} is the inverse of the warp denoted by Fₖ);
X-hat⁽ⁿ⁾=hypothetical or simulated high-resolution frame 306 in the reference projector frame buffer 120, as defined in Equation II, for iteration number n;
X=desired high-resolution frame 308;
β=smoothing constant; and
∇²=Laplacian operator.

Equation X may be intuitively understood as an iterative process of computing an error in the reference projector 118 coordinate system and projecting it back onto the sub-frame data. In one embodiment, sub-frame generator 108 (FIG. 1) is configured to generate sub-frames 110 in real-time using Equation X. The generated sub-frames 110 are optimal in one embodiment because they maximize the probability that the simulated high-resolution image 306 (X-hat) is the same as the desired high-resolution image 308 (X), and they minimize the error between the simulated high-resolution image 306 and the desired high-resolution image 308. Equation X can be implemented very efficiently with conventional image processing operations (e.g., transformations, down-sampling, and filtering). The iterative algorithm given by Equation X converges rapidly in a few iterations and is very efficient in terms of memory and computation (e.g., a single iteration uses two rows in memory; and multiple iterations may also be rolled into a single step). The iterative algorithm given by Equation X is suitable for real-time implementation, and may be used to generate optimal sub-frames 110 at video rates, for example.

To begin the iterative algorithm defined in Equation X, an initial guess, Yₖ⁽⁰⁾, for the sub-frames 110 is determined. In one embodiment, the initial guess for the sub-frames 110 is determined by texture mapping the desired high-resolution frame 308 onto the sub-frames 110. In one form of the invention, the initial guess is determined from the following Equation XI:

Yₖ⁽⁰⁾=DIₖFₖ^{T}X Equation XI

where:
k=index for identifying the projectors 112;
Yₖ⁽⁰⁾=initial guess at the sub-frame data for the sub-frame 110 for the kth projector 112;
D=down-sampling matrix;
Iₖ=interpolation filter;
Fₖ^{T}=Transpose of operator, Fₖ, from Equation II (in the image domain, Fₖ^{T} is the inverse of the warp denoted by Fₖ); and
X=desired high-resolution frame 308.

Thus, as indicated by Equation XI, the initial guess (Yₖ⁽⁰⁾) is determined by performing a geometric transformation (Fₖ^{T}) on the desired high-resolution frame 308 (X), and filtering (Iₖ) and down-sampling (D) the result. The particular combination of neighboring pixels from the desired high-resolution frame 308 that are used in generating the initial guess (Yₖ⁽⁰⁾) will depend on the selected filter kernel for the interpolation filter (Iₖ).

In another form of the invention, the initial guess, Yₖ⁽⁰⁾, for the sub-frames 110 is determined from the following Equation XII

Yₖ⁽⁰⁾=DFₖ^{T}X Equation XII

where:
k=index for identifying the projectors 112;
Yₖ⁽⁰⁾=initial guess at the sub-frame data for the sub-frame 110 for the kth projector 112;
D=down-sampling matrix;
Fₖ^{T}=Transpose of operator, Fₖ, from Equation II (in the image domain, Fₖ^{T} is the inverse of the warp denoted by Fₖ); and
X=desired high-resolution frame 308.

Equation XII is the same as Equation XI, except that the interpolation filter (Iₖ) is not used.

Several techniques are available to determine the geometric mapping (Fₖ) between each projector 112 and the reference projector 118, including manually establishing the mappings, or using camera 122 and calibration unit 124 (FIG. 1) to automatically determine the mappings. Techniques for determining geometric mappings that are suitable for use in one form of the present invention are described in U.S. patent application Ser. No. 10/356,858, filed Feb. 3, 2003, entitled “MULTIFRAME CORRESPONDENCE ESTIMATION”, and U.S. patent application Ser. No. 11/068,195, filed Feb. 28, 2005, entitled “MULTI-PROJECTOR GEOMETRIC CALIBRATION”, both of which are hereby incorporated by reference herein.

In one embodiment, if camera 122 and calibration unit 124 are used, the geometric mappings between each projector 112 and the camera 122 are determined by calibration unit 124. These projector-to-camera mappings may be denoted by Tₖ, where k is an index for identifying projectors 112. Based on the projector-to-camera mappings (Tₖ), the geometric mappings (Fₖ) between each projector 112 and the reference projector 118 are determined by calibration unit 124, and provided to sub-frame generator 108. For example, in a display system 100 with two projectors 112A and 112B, assuming the first projector 112A is the reference projector 118, the geometric mapping of the second projector 112B to the first (reference) projector 112A can be determined as shown in the following Equation XIII:

F₂=T₂T₁⁻¹ Equation XIII

where:
F₂=operator that maps a low-resolution sub-frame 110 of the second projector 112B to the first (reference) projector 112A;
T₁=geometric mapping between the first projector 112A and the camera 122; and
T₂=geometric mapping between the second projector 112B and the camera 122.

In one embodiment, the geometric mappings (Fₖ) are determined once by calibration unit 124, and provided to sub-frame generator 108. In another embodiment, calibration unit 124 continually determines (e.g., once per frame 106) the geometric mappings (Fₖ), and continually provides updated values for the mappings to sub-frame generator 108.

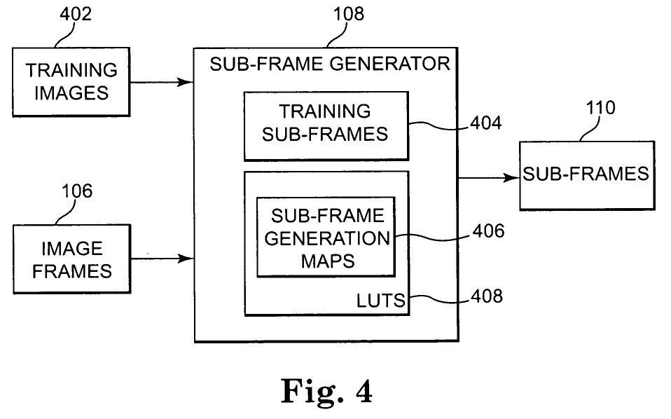

In one form of the invention, sub-frames 110 are generated in two phases. The first phase is an off-line training phase during which sub-frame generation maps are generated from training images. FIG. 4 is a diagram illustrating the two phases of the sub-frame generation process according to one embodiment of the present invention. As shown in FIG. 4, high-resolution training images 402 are provided to sub-frame generator 108 during the training phase. Based on the received training images 402, the sub-frame generator 108 generates and stores corresponding low-resolution training sub-frames 404. Sub-frame generator 108 then generates sub-frame generation maps 406 during the training phase based on the training sub-frames 404 and the training images 402, and stores the maps 406 in lookup tables 408. In one form of the invention, a separate sub-frame generation map 406 and lookup table 408 is provided for each projector 112 in multi-projector system 100.

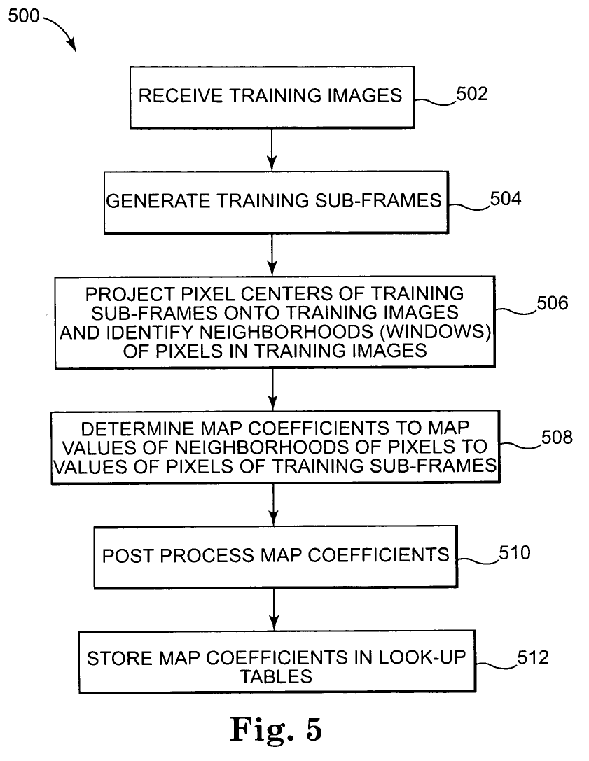

The second phase is a run-time phase during which the generated maps 406 are applied by sub-frame generator 108 to generate low-resolution sub-frames 110 from high-resolution image frames 106 during normal operation of the multi-projector system 100. These two phases are described in further detail below with reference to FIGS. 5-9. In another form of the invention, the training phase is an on-line training phase that occurs at run-time. In this form of the invention, the system 100 is trained during normal operation of the system 100 based on the actual image content to be projected (i.e., high-resolution image frames 106), rather than using a separate set of training images 402. In this embodiment, the high-resolution image frames 106 serve as the training images 402.

FIG. 5 is a flow diagram illustrating a method 500 for generating sub-frame generation maps 406 during a training phase of multi-projector system 100 according to one embodiment of the present invention. In one form of the invention, sub-frame generator 108 is configured to perform method 500. At 502 in method 500, sub-frame generator 108 receives a set of N high-resolution training images 402. In one form of the invention, the training images 402 are white noise images (e.g., images with substantially spatially uncorrelated noise). The use of white noise images results in maps 406 that are sensitive to the projector configuration (e.g., projector position and orientation) and the misalignment between projectors 112, and that are content independent. In another form of the invention, the training images 402 are impulse images (e.g., images with most of the pixels have a zero value, and one or more impulse pixels have a non-zero value, such as a value of one). In yet another form of the invention, a library of representative images is used for the training images 402, such as a number of example frames from the actual content to be projected by system 100. In one embodiment, the training images 402 have the same resolution as the image frames 106 that are used during normal operation of system 100.

At 504, sub-frame generator 108 generates a set of training sub-frames 404 based on the received training images 402. In one form of the invention, for each received training image 402, sub-frame generator 108 generates a corresponding training sub-frame 404 for each projector 112 in the multi-projector system 100. Thus, if there are 100 training images 402, for example, and 5 projectors 112 in system 100, then sub-frame generator 108 will generate 500 training sub-frames 404 at 504 (i.e., 100 training sub-frames 404 for each projector 112). In one embodiment, the training sub-frames 404 generated at 504 have the same resolution as the sub-frames 110 that are generated during normal operation of system 100. The training images 402 and image frames 106 according to one form of the invention have a higher resolution than the training sub-frames 404 and sub-frames 110.

In one embodiment, the set of training sub-frames 404 are generated at 504 according to the techniques described above, where initial guesses for the sub-frames are determined from the high resolution training image data 402 (see, e.g., Equations XI and XII and corresponding description), and the set of sub-frames 404 are then generated from the initial guesses using an iterative process (see, e.g., Equation XV and corresponding description).

Since the training sub-frames 404 are generated at 504 in an off-line procedure in one embodiment, rather than during normal operation of the multi-projector system 100, the sub-frame generation algorithm that is used by sub-frame generator 108 to generate the sub-frames 404 can be based on a sophisticated image formation model that incorporates high-quality projector calibration information, regularization, projector luminance correction, highly-accurate point spread functions to represent pixel shapes, and super-sampling. Generating sub-frames based on a sophisticated image formation model is more time consuming than if a simpler model were used, but since the sub-frames 404 are generated during the training phase, time is less of a concern than during normal operation of system 100. Techniques for incorporating some of these features into the sub-frame generation process are described in U.S. patent application Ser. No. 10/356,858, filed Feb. 3, 2003, entitled MULTIFRAME CORRESPONDENCE ESTIMATION; U.S. patent application Ser. No. 11/068,195, filed Feb. 28, 2005, entitled MULTI-PROJECTOR GEOMETRIC CALIBRATION; U.S. patent application Ser. No. 11/258,624, filed on Oct. 26, 2005, and entitled LUMINANCE BASED MULTIPLE PROJECTOR SYSTEM; and U.S. patent application Ser. No. 11/301,060, filed on Dec. 12, 2005, and entitled SYSTEM AND METHOD FOR DISPLAYING AN IMAGE; all of which are hereby incorporated by reference herein.

In one form of the invention, rather than generating the training sub-frames 404 directly from the training images 402, the training images 402 are first mapped to target profiles, such as target luminance profiles or CIE XYZ target profiles, and then the training sub-frames 404 are generated from the target profiles. In one embodiment, the training sub-frames 404 are generated from target profiles using the techniques disclosed in U.S. patent application Ser. No. 11/301,060, filed on Dec. 12, 2005, and entitled SYSTEM AND METHOD FOR DISPLAYING AN IMAGE, which is incorporated by reference.

At 506 in method 500, for each low-resolution training sub-frame 404 generated at 504, sub-frame generator 108 “projects” each pixel center of the training sub-frame 404 onto the high-resolution training image 402 corresponding to that training sub-frame 404, and identifies a neighborhood or set of W×W high-resolution pixels in the training image 402 located around the projected point. The statement above that the sub-frame generator 108 “projects” a pixel center means that the geometric mapping or warp (Fₖ) is used to map or “project” the pixel centers of the sub-frames 404 onto corresponding points in the high-resolution training image 402 (see, e.g., FIG. 3, Equations I, II, and XIII, and corresponding descriptions).

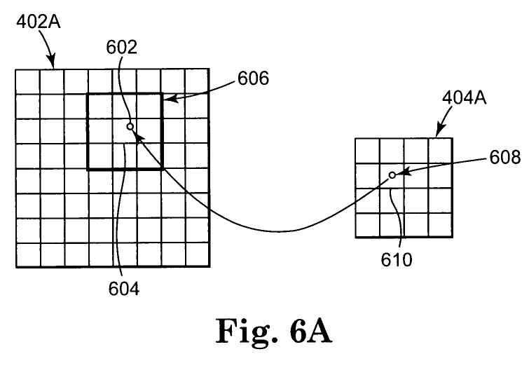

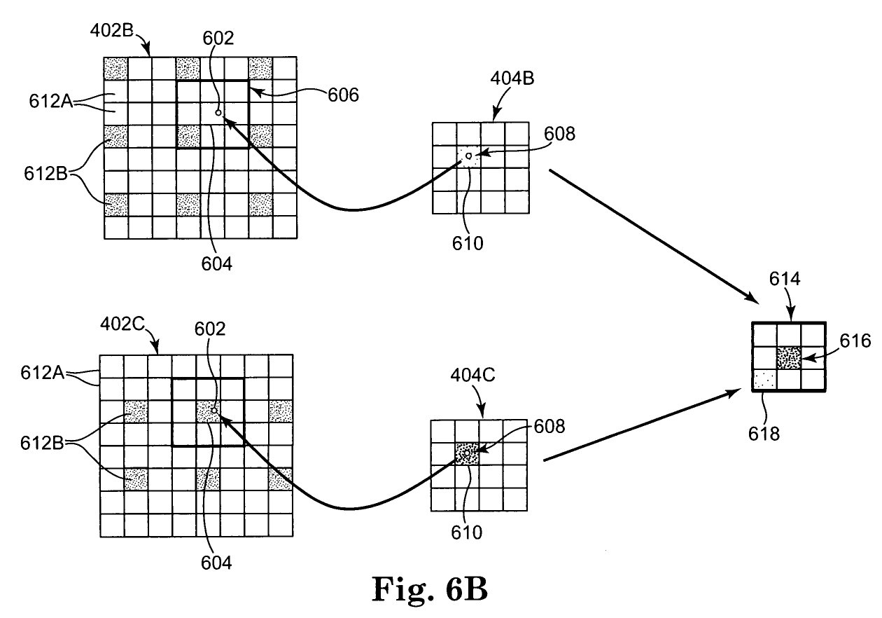

FIG. 6A is a diagram illustrating the projection of a pixel center performed at 506 in method 500 according to one embodiment of the present invention. As shown in FIG. 6A, the pixel center 608 of a pixel 610 at location [m,n] in a 4×4 pixel training sub-frame 404A is mapped or projected at 506 to a corresponding point 602 of a pixel 604 at location [k,l] in an 8×8 pixel training image 402A. A set or neighborhood 606 of pixels in the training image 402A is identified at 506 as the W×W window of pixels centered at pixel 604, where “W” equals three in the illustrated embodiment. In another embodiment, the W×W window 606 is centered around the point 602, such that if the point 602 is not in the center of a pixel, the W×W window 606 will not be pixel aligned. If the W×W window 606 is not pixel aligned, the pixel values for the window 606 can be obtained by rounding to the nearest integer location.

At 508 in method 500, for each pixel of each training sub-frame 404, sub-frame generator 108 determines a set of map coefficients that map the values of the corresponding neighborhood 606 of pixels in the training image 402 (identified at 506) to the value of the pixel in the training sub-frame 404. In one embodiment, the map coefficients are determined at 508 as described in further detail below with reference to Equations XIV to XX.

The pixel values of the training sub-frames 404 are represented by the following Equation XIV:

$${Y}_{p , t} [ m , n ] = {\sum }_{k , l} {C}_{p} [ m , n , k , l ] {N}_{t} [ m , n , k , l ] \qquad Equation XIV$$

Where:
p=index for identifying projectors 112;
t=index for identifying training images 402;
[m,n]=pixel location in a training sub-frame 404;
[k,l]=pixel location in a neighborhood 606 of a training image 402;
Y_{p,t}[m,n]=value of pixel at location [m,n] in the training sub-frame 404 for the pth projector 112 and corresponding to the tth training image 402;
Cₚ[m, n, k, l]=coefficients for multiplying the pixel values of the neighborhood 606 of pixels at locations [k,l] in a training image 402, which correspond to sub-frame location [m,n] in a training sub-frame 404 for the pth projector 112; and
Nₜ[m,n,k,l]=pixel values of the neighborhood 606 of pixels at locations [k,l] in a training image 402, which correspond to sub-frame location [m,n].

Thus, as indicated by Equation XIV, the value (Y) of any given pixel in a training sub-frame 404 is defined as the summation over the pixel locations [k,l] in the neighborhood 606 of the corresponding training image 402 of the product of the map coefficients (C) for that neighborhood 606 and the neighborhood pixel values (N) of the pixels in that neighborhood 606.

Equation XIV may be written in matrix form as shown by the following Equation XV:

$$[ \begin{matrix}{N}_{1} [ m , n , 0 , 0 ] & ⋯ & {N}_{1} [ m , n , W - 1 , W - 1 ] \\ ⋮ & ⋰ & ⋮ \\ {N}_{T} [ m , n , 0 , 0 ] & ⋯ & {N}_{T} [ m , n , W - 1 , W - 1 ]\end{matrix} ] [ \begin{matrix}{C}_{p} [ m , n , 0 , 0 ] \\ ⋮ \\ {C}_{p} [ m , n , W - 1 , W - 1 ]\end{matrix} ] = [ \begin{matrix}{Y}_{p , 1} [ m , n ] \\ ⋮ \\ {Y}_{p , T} [ m , n ]\end{matrix} ] \qquad Equation XV$$

Where:
p=index for identifying projectors 112;
T=total number of training images 402;
[m,n]=pixel location in a training sub-frame 404;
W=number of pixels in a row or column of a neighborhood 606;
Y_{p,1}[m,n]=value of pixel at location [m,n] in a training sub-frame 404 for the pth projector 112 corresponding to the 1st training image 402;
Y_{p,T}[m,n]=value of pixel at location [m,n] in a training sub-frame 404 for the pth projector 112 corresponding to the Tth (last) training image 402;
Cₚ[m, n, 0, 0]=coefficient for multiplying the value of the training image 402 pixel at location [0,0] in the neighborhood 606 corresponding to sub-frame location [m,n] in a training sub-frame 404 for the pth projector 112;
Cₚ[m, n, W−1, W−1]=coefficient for multiplying the value of the training image 402 pixel at location [W−1, W−1] in the neighborhood 606 corresponding to sub-frame location [m,n] in a training sub-frame 404 for the pth projector 112;
N₁[m,n,0,0]=value of the pixel in the 1^{st} training image 402 at location [0,0] in the neighborhood 606 corresponding to sub-frame location [m,n];
N₁[m,n, W−1,W−1]=value of the pixel in the 1^{st} training image 402 at location [W−1, W−1] in the neighborhood 606 corresponding to sub-frame location [m,n];
N_{T}[m,n,0,0]=value of the pixel in the Tth (last) training image 402 at location [0,0] in the neighborhood 606 corresponding to sub-frame location [m,n]; and
N_{T}[m,n,W−1,W−1]=value of the pixel in the Tth (last) training image 402 at location [W−1,W−1] in the neighborhood 606 corresponding to sub-frame location [m,n].

As shown by Equation XV, there is one row in the neighborhood matrix, Nₜ, for each training image 402, so each row corresponds to a particular training image 402. Each row in the neighborhood matrix, Nₜ, includes W×W elements, which are the pixel values for the neighborhood 606 corresponding to sub-frame location [m,n] in the training image 402 corresponding to that row. The sub-frame value vector, Y_{p,t}, on the right hand side of the equals sign in Equation XV, is a 1×T vector, where T represents the total number of training images 402. Each element in the sub-frame value vector, Y_{p,t}, corresponds to a particular training image 402. All of the elements in the sub-frame value vector, Y_{p,t}, also correspond to a particular one of the projectors 112, which is indicated by the subscript “p”. Thus, the elements in the sub-frame value vector, Y_{p,t}, give the sub-frame pixel values for one sub-frame location [m,n] in the T training sub-frames 404 for the pth one of the projectors 112. The unknown coefficients to be solved for are represented in Equation XV by a map coefficient vector, Cₚ, which is a 1×W² vector. It is assumed that, for a given projector 112 (index p), and a given sub-frame location [m,n], the elements in the map coefficient vector, Cₚ, are the same for all of the T training images 402.

In one embodiment, the unknown coefficients, Cₚ, in the map coefficient vector, Cₚ, in Equation XV are determined by sub-frame generator 108 using a pseudo-inverse approach, as shown by the following Equation XVI:

C[m,n]=(N^{T}[m,n]N[m,n])⁻¹N^{T}[m,n]Y[m,n] Equation XVI

Where:
[m,n]=pixel location in a training sub-frame 404;
C[m,n]=vector of map coefficients corresponding to pixel location [m,n] in a training sub-frame 404;
N[m,n]=matrix of pixel values for a training image 402 for the neighborhood 606 corresponding to sub-frame pixel location [m,n];
N^{T}[m,n]=transpose of the matrix, N[m,n]; and
Y[m,n]=vector of pixel values at sub-frame location [m,n] in the training sub-frames 404 for a given projector 112.

In one embodiment, Equation XVI is used by sub-frame generator 108 to determine a set of W×W map coefficients for each sub-frame pixel location for each projector 112, where W equals 3 in one embodiment. Thus, each projector 112 will have a corresponding sub-frame generation map 406 that includes a set of W×W map coefficients for each sub-frame pixel location of that projector 112.

In one form of the invention, the sub-frame pixel values in generated sub-frames 110 should fall within a desired range, such as in the range of 0 to 1. However, application of the map coefficients to a given high resolution image may result in sub-frame pixel values that fall outside the desired range. Thus, in one embodiment, a sigma constraint is used to clip values that fall outside the desired range, with sigma being defined as shown in the following Equation XVII:

$${Y}_{p , t} [ m , n ] = σ ( {\sum }_{k , l} {C}_{p} [ m , n , k , l ] {N}_{t} [ m , n , k , l ] ) \qquad Equation XVIII$$

Thus, as shown by Equation XVII, if a given sub-frame pixel value, u, falls within the range of 0 to 1, the value is not changed, but if the sub-frame pixel value falls outside the range of 0 to 1, the value is changed to 0. The sigma function defined in Equation XVII may be incorporated into Equation XIV as shown by the following Equation XVIII:

$$σ ( u ) = \{ \begin{matrix}u & 0 \leq u \leq 1 \\ 0 & else\end{matrix} \qquad Equation XVII$$

Where:
σ=sigma function defined in Equation XVII;
p=index for identifying projectors 112;
t=index for identifying training images 402;
[m,n]=pixel location in a training sub-frame 404;
[k,l]=pixel location in a neighborhood 606 of a training image 402;
Y_{p,t}[m,n]=value of pixel at location [m,n] in the training sub-frame 404 for the pth projector 112 and corresponding to the tth training image 402;
Cₚ[m, n, k, l]=coefficients for multiplying the pixel values of the neighborhood 606 of pixels at locations [k,l] in a training image 402, which correspond to sub-frame location [m,n] in a training sub-frame 404 for the pth projector 112; and
Nₜ[m,n,k,l]=pixel values of the neighborhood 606 of pixels at locations [k,l] in a training image 402, which correspond to sub-frame location [m,n].

A pseudo-inverse approach for determining the map coefficient values was defined above in Equation XVI. In another form of the invention, a gradient algorithm, such as a conjugate gradient, is used to determine the coefficient values. In this form of the invention, an error function, J, is defined as the difference between an actual sub-frame pixel value (Y[m,n]) and a “predicted” sub-frame pixel value that is generated by multiplying the map coefficients by a neighborhood 606 of high resolution pixel values (Cₚ[m,n,k,l]N,[m,n,k,l]). In one embodiment, the error function, J, is defined as shown in the following Equation XIX, which also incorporates the sigma function, σ, defined in Equation XVII:

$$J = {\sum }_{t = 1}^{T} {\{ {Y}_{p , t} [ m , n ] - σ ( {\sum }_{k , l} {C}_{p} [ m , n , k , l ] {N}_{t} [ m , n , k , l ] ) \}}^{2} \qquad Equation XIX$$

Where:
J=error function;
σ=sigma function defined in Equation XVII;
p=index for identifying projectors 112;
t=index for identifying training images 402;
T=total number of training images 402;
[m,n]=pixel location in a training sub-frame 404;
[k,l]=pixel location in a neighborhood 606 of a training image 402;
Y_{p,t}[m,n]=value of pixel at location [m,n] in the training sub-frame 404 for the pth projector 112 and corresponding to the tth training image 402;
Cₚ[m, n, k, l]=coefficients for multiplying the pixel values of the neighborhood 606 of pixels at locations [k,l] in a training image 402, which correspond to sub-frame location [m,n] in a training sub-frame 404 for the pth projector 112; and
Nₜ[m,n,k,l]=pixel values of the neighborhood 606 of pixels at locations [k,l] in a training image 402, which correspond to sub-frame location [m,n].

The gradient of the error function, J, in Equation XIX with respect to the unknown coefficients, Cₚ[m,n,k,l], is determined, as shown in the following Equation XX:

$$\frac{\partial J}{\partial {C}_{p}^{( n )} [ m , n , k , l ]} = {\sum }_{t = 1}^{T} {σ}^{′} ( {\sum }_{k , l} {C}_{p}^{( n )} [ m , n , k , l ] {N}_{t} [ m , n , k , l ] ) E \qquad Equation XX$$

Where:
J=error function;
σ′=derivative of sigma function defined in Equation XVII;
p=index for identifying projectors 112;
t=index for identifying training images 402;
T=total number of training images 402;
[m,n]=pixel location in a training sub-frame 404;
[k,l]=pixel location in a neighborhood 606 of a training image 402;
Cₚ[m, n, k, l]=coefficients for multiplying the pixel values of the neighborhood 606 of pixels at locations [k,l] in a training image 402, which correspond to sub-frame location [m,n] in a training sub-frame 404 for the pth projector 112;
Nₜ[m,n,k,l]=pixel values of the neighborhood 606 of pixels at locations [k,l] in a training image 402, which correspond to sub-frame location [m,n]; and
E=error term, which is the same as the equation to the right of the summation over t symbol in Equation XIX, without squaring the total.

The optimal coefficients, Cₚ[m,n,k,l] are then determined from Equation XX using conventional optimization techniques. Additional constraints may also be incorporated into the problem, such as smoothness constraints. A modified version of Equation XX can be used to update the map coefficients Cₚ based on each individual training image 402, rather than based on a plurality of training images 402 (e.g., the modified equation would not use a summation over the total number of training images T as shown in the above Equation XX).

Returning to method 500 (FIG. 5), after the map coefficients are determined at 508, the map coefficients are post processed at 510 for smoothness, and to remove noise. In order to get a good estimation of optimal maps 406, the number of high-resolution training images 402 received at 502 in method 500 should be relatively large (e.g., 100) to avoid noise introduced by small number sampling error. The large number of training images 402 translates into a need for large memory and increased computational complexity. One solution to reduce memory and computational complexity is to use a relatively small number of training images (e.g., 30), but perform a post-processing step at 510 to filter the generated maps 406. In one embodiment, the generated maps 406 are filtered at 510 using a low-pass filter to help ensure smoothness from pixel to pixel and to reduce noise introduced due to small number sampling. The filtering performed at 510 according to one form of the invention is represented by the following Equation XXI:

$${\tilde{C}}_{p} ( m , n ) = {\sum }_{( x , y ) ∈ N ( m , n )} f ( x , y ) \cdot {\tilde{C}}_{p} ( x , y ) \qquad Equation XXI$$

Where:
(m,n)=pixel location in a training sub-frame 404;
(x,y)=set of pixel locations in a training sub-frame 404;
N(m,n)=neighborhood of pixels in a training sub-frame 404 centered at location (m,n);
\tilde{C}ₚ(m,n)=map coefficients corresponding to sub-frame location (m,n) after filtering at 510 in method 500;
\tilde{C}ₚ(x,y)=map coefficients determined at 508 in method 500 at the set of sub-frame locations (x,y); and
f(x,y)=two-dimensional low-pass filter defined over the neighborhood, N(m,n).

At 512 in method 500, the map coefficients generated by method 500 are stored as sub-frame generation maps 406 in lookup tables 408 (FIG. 4) for use by sub-frame generator 108 during normal operation of multi-projector system 100 to generate sub-frames 110.

In an alternative form of the invention, rather than determining map coefficients at 508 for every pixel location in training sub-frames 404, map coefficients are determined for a subset of the sub-frame pixel locations, such as the pixels located on subsampled grid locations (e.g., subsampled by 2 in both row and column directions). The reduced set of map coefficients is stored as maps 406 in lookup tables 408. When applying the maps 406 with the reduced set of map coefficients during normal operation of system 100, for those pixels whose map was not computed in the training stage, map coefficients are generated by sub-frame generator 108 during normal operation of system 100 by linear interpolation from previously computed map coefficients corresponding to neighboring sub-frame pixels. In this manner, less memory is needed for the look-up tables 408. In another embodiment, rather than using linear interpolation, filters are constructed based on Eigen decomposition and are used to generate map coefficients from previously computed map coefficients. In another embodiment, image regions where the maps 406 are nearly constant can share the same coefficient set, further reducing memory usage.

In one form of the invention, the sub-frame generation maps 406 (FIG. 4) are generated with method 500 (FIG. 5) using impulse images for the training images 402. In this form of the invention, the training images 402 received at 502 are impulse images, and the received impulse images are used to generate the training sub-frames 404 at 504 in method 500. At 506 in method 500, for each low-resolution training sub-frame 404 generated at 504, sub-frame generator 108 “projects” each pixel center of the training sub-frame 404 onto the high-resolution impulse training image 402 corresponding to that training sub-frame 404, and identifies a neighborhood or set of W×W high-resolution pixels in the impulse training image 402 located around the projected point. The statement above that the sub-frame generator 108 “projects” a pixel center means that the geometric mapping or warp (Fₖ) is used to map or “project” the pixel centers of the sub-frames 404 onto corresponding points in the high-resolution impulse training image 402 (see, e.g., FIG. 3, Equations I, II, and XIII, and corresponding descriptions).

FIG. 6B is a diagram illustrating the projection of a pixel center performed at 506 in method 500 using impulse training images 402 according to one embodiment of the present invention. Two impulse training images 402 (i.e., 402B and 402C) are shown in FIG. 6B. Each of the impulse training images 402B and 402C includes a plurality of pixels 612A having a zero value, and a plurality of impulse pixels 612B having a non-zero value.

As shown in FIG. 6B, the pixel center 608 of a pixel 610 at location [m,n] in a first 4×4 pixel training sub-frame 404B is mapped or projected at 506 to a corresponding point 602 of a pixel 604 at location [k,l] in a first 8×8 pixel impulse training image 402B. A set or neighborhood 606 of pixels in the first impulse training image 402B is identified at 506 as the W×W window of pixels centered at pixel 604, where “W” equals three in the illustrated embodiment.

The pixel center 608 of a pixel 610 at location [m,n] in a second 4×4 pixel training sub-frame 404C is mapped or projected at 506 to a corresponding point 602 of a pixel 604 at location [k,l] in a second 8×8 pixel impulse training image 402C. A set or neighborhood 606 of pixels in the second impulse training image 402B is identified at 506 as the W×W window of pixels centered at pixel 604, where “W” equals three in the illustrated embodiment.

At 508 in method 500, for each pixel of each training sub-frame 404, sub-frame generator 108 determines a set of map coefficients that map the values of the corresponding neighborhood 606 of pixels in the impulse training image 402 (identified at 506) to the value of the pixel in the training sub-frame 404. In one embodiment, the values of the map coefficients determined at 508 are the same as the values of corresponding pixels in the training sub-frames 404. For example, as shown in FIG. 6B, filter 614 corresponds to neighborhood 606 in the illustrated embodiment. The coefficient for pixel location 618 in filter 614, which corresponds to the position of the impulse pixel 612B within the neighborhood 606 of the first impulse training image 402B (i.e., lower left corner), will have the same value as the pixel 610 in the first training sub-frame 404B. The coefficient for pixel location 616 in filter 614, which corresponds to the position of the impulse pixel 612B within the neighborhood 606 of the second impulse training image 402C (i.e., middle), will have the same value as the pixel 610 in the second training sub-frame 404C. In one form of the invention, in addition to the two impulse training images 402B and 402C, seven more impulse training images 402 are used to generate seven more corresponding training sub-frames 404, and thereby obtain data to fill in the remaining seven coefficients of filter 614. In one form of the invention, the nine impulse training images 402 include impulse pixels 612B that are positioned such that, if the impulse training images 402 were superimposed, the impulse pixels 612B would cover every pixel position.

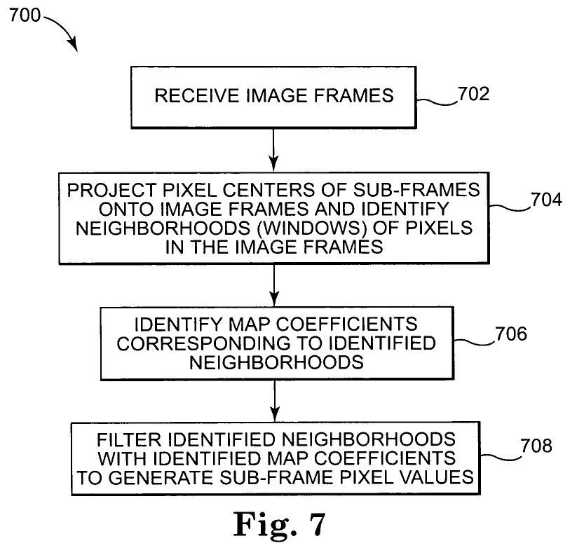

As mentioned above with respect to FIG. 4, after the training phase in which the maps 406 are generated and stored, system 100 is then configured for a run-time phase, during which the generated maps 406 are applied by sub-frame generator 108 to generate low-resolution sub-frames 110 from high-resolution image frames 106 during normal operation of the multi-projector system 100. FIG. 7 is a flow diagram illustrating a method 700 for generating low-resolution sub-frames 110 from high-resolution image frames 106 during normal operation of system 100 according to one embodiment of the present invention. In one embodiment, sub-frame generator 108 is configured to perform method 700.

At 702 in method 700, sub-frame generator 108 receives image frames 106. In one form of the invention, for each received image frame 106, sub-frame generator 108 generates a corresponding sub-frame 110 for each projector 112 in the multi-projector system 100. At 704, for each low-resolution sub-frame 110 to be generated, sub-frame generator 108 “projects” each pixel center of the sub-frame 110 onto the high-resolution image frame 106 received at 702 corresponding to that sub-frame 110, and identifies a neighborhood or set of W×W high-resolution pixels in the image frame 106 located around the projected point. The statement above that the sub-frame generator 108 “projects” a pixel center means that the geometric mapping or warp (Fₖ) is used to map or “project” the pixel centers of the sub-frames 110 onto corresponding points in the high-resolution image frame 106 (see, e.g., FIG. 3, Equations I, II, and XIII, and corresponding descriptions).

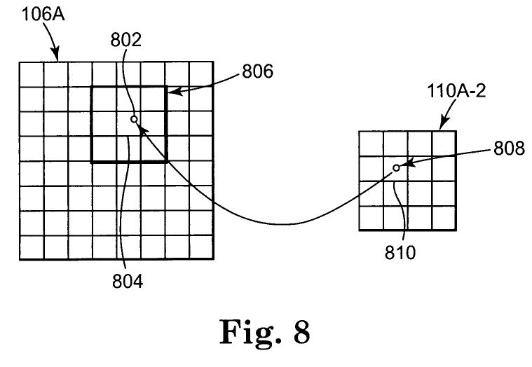

FIG. 8 is a diagram illustrating the projection of a pixel center performed at 704 in method 700 according to one embodiment of the present invention. As shown in FIG. 8, the pixel center 808 of a pixel 810 at location [m,n] in a 4×4 pixel sub-frame 110A-2 is mapped or projected at 704 to a corresponding point 802 of a pixel 804 at location [k,l] in an 8×8 pixel image frame 106A. A set or neighborhood 806 of pixels in the image frame 106A is identified at 704 as the W×W window of pixels centered at pixel 804, where “W” equals three in the illustrated embodiment.

At 706 in method 700, for each neighborhood 806 of pixels identified at 704, sub-frame generator 108 identifies the map coefficients for that neighborhood 806. In one form of the invention, the map coefficients are identified and retrieved at 706 from lookup tables 408. The position of a sub-frame pixel to be calculated is used by sub-frame generator 108 to index the lookup table 408, which returns a W×W set of map coefficients (e.g., 3×3=9 coefficients) corresponding to that sub-frame pixel position.

At 708, for each neighborhood 806 of pixels identified at 704, sub-frame generator 108 filters the neighborhood 806 with its corresponding map coefficients identified at 706 to generate the value of the sub-frame pixel corresponding to that neighborhood 806. In one embodiment, sub-frame generator 108 generates a sub-frame pixel value at 708 by multiplying each map coefficient by its corresponding neighborhood pixel value, and then adding the results of the multiplications. In one form of the invention, the sub-frame pixel values are computed at 708 based on the following Equation XXII:

$${Y}_{p} [ m , n ] = σ ( {\sum }_{k , l} {C}_{p} [ m , n , k , l ] N [ m , n , k , l ] ) \qquad Equation XXII$$

Where:
σ=sigma function defined in Equation XVII;
p=index for identifying projectors 112;
t=index for identifying image frames 106;
[m,n]=pixel location in a sub-frame 110;
[k,l]=pixel location in a neighborhood 806 of an image frame 106;
Yₚ[m,n]=value of pixel at location [m,n] in a sub-frame 110 for the pth projector 112;
Cₚ[m, n, k, l]=coefficients for multiplying the pixel values of the neighborhood 806 of pixels at locations [k,l] in an image frame 106, which correspond to sub-frame location [m,n] in a sub-frame 110 for the pth projector 112; and
N[m,n,k,l]=pixel values of the neighborhood 806 of pixels at locations [k,l] in an image frame 106, which correspond to sub-frame location [m,n].

Equation XXII above incorporates the sigma function, σ, so that sub-frame pixel values that exceed the range [0,1] are clipped.

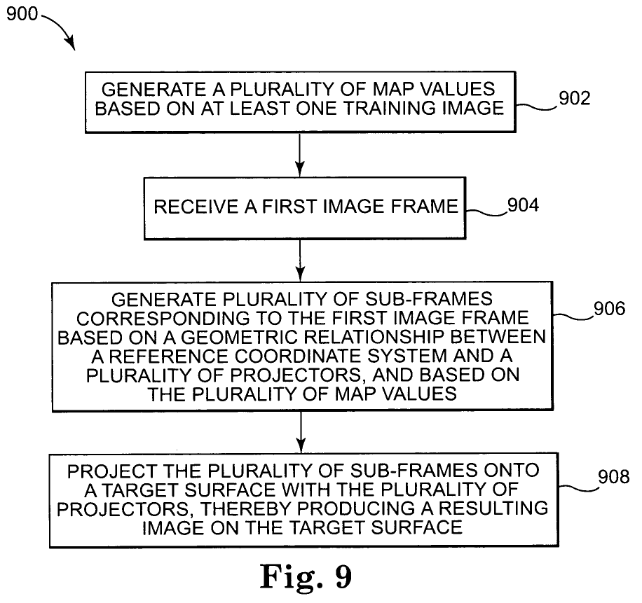

FIG. 9 is a flow diagram illustrating a method 900 of displaying an image with display system 100 (FIG. 1) according to one embodiment of the present invention. At 902, sub-frame generator 108 generates a plurality of map values based on at least one training image 402. At 904, a first image frame 106 is received by the sub-frame generator 108. At 906, a plurality of sub-frames 110 corresponding to the first image frame 106 are generated by the sub-frame generator 108 based on a geometric relationship between a reference coordinate system and a plurality of projectors 112, and based on the plurality of map values. At 908, the plurality of sub-frames 110 are projected onto a target surface 116 with the plurality of projectors 112, thereby producing a resulting image 114 on the target surface 116.

In one form of the invention, the maps 406 are used to generate sub-frame values for only a subset of the pixel locations in a given sub-frame 110, and another technique, such as texture mapping or a smoothing filter, is used to generate the sub-frame values for the remainder of the pixel locations in the sub-frame 110. In one embodiment, a preliminary assessment is made for each image frame 106 using a gradient filter, to identify regions in the image frame 106 that are appropriate for using the maps 406, and identify other regions in the image frame 106 that are appropriate for using another technique. In this manner, the number of look-ups into tables 408 is reduced. In another embodiment, the sub-frame values are generated by essentially blending the maps 406 and a second technique, such as texture mapping or a smoothing filter. For example, in a region of an image frame 106 with a high gradient, the maps 406 will be used primarily or exclusively to generate sub-frame values for sub-frame pixels corresponding to this region, and in a region of an image frame 106 with a low gradient, texture mapping or a smoothing filter is used primarily or exclusively to generate sub-frame values for sub-frame pixels corresponding to this region. Thus, in this embodiment, the amount of smoothing will vary throughout the image based on the gradient at various locations in the image.

If any of the calibration parameters (e.g., geometric mappings (Fₖ)) of system 100 change after the sub-frame generation maps 406 have been generated, the generated sub-frames 110 may not be accurate. In one embodiment, sub-frame generator 108 is configured to update the sub-frame generation maps 406 during the run-time phase of system 100, which helps to compensate for any changes in system 100. In one form of the invention, the maps 406 are updated gradually over time during the run-time phase to avoid any adverse affects on the performance of system 100.

In one embodiment, the sub-frame generation maps 406 include luminance maps and chrominance maps for each projector 112. The luminance maps are generated by training sub-frame generator 108 on the luminance information in training images 402, and the chrominance maps are generated by training sub-frame generator 108 on the chrominance information in training images 402. In another embodiment, only luminance maps are generated for each projector 112, and a different approach, such as texture mapping, is used to generate chrominance information for sub-frames 110.

In yet another embodiment, the sub-frame generation maps 406 include three maps for each color channel (e.g., Red, Green, and Blue) of each projector 112 (e.g., nine different sub-frame generation maps 406 for each projector 112). In this embodiment, the maps 406 for each projector 112 include a red-to-red map, a green-to-red map, a blue-to-red map, a red-to-green map, a green-to-green map, a blue-to-green map, a red-to-blue map, a green-to-blue map, and a blue-to-blue map. The maps for each color channel for each projector 112 are generated by training sub-frame generator 108 on the red, green, and blue color information in training images 402. For a given projector 112, the red color information for sub-frames 110 is generated by applying the red-to-red map to the red color information in the image frames 106, applying the green-to-red map to the green color information in the image frames 106, and applying the blue-to-red map to the blue color information in the image frames 106. The green color information for sub-frames 110 is generated by applying the red-to-green map to the red color information in the image frames 106, applying the green-to-green map to the green color information in the image frames 106, and applying the blue-to-green map to the blue color information in the image frames 106. The blue color information for sub-frames 110 is generated by applying the red-to-blue map to the red color information in the image frames 106, applying the green-to-blue map to the green color information in the image frames 106, and applying the blue-to-blue map to the blue color information in the image frames 106.

One form of the present invention enables scalable multi-projector systems to be deployed by folding run time complexity into a pre-projection training phase. This form of the invention improves on previous sub-frame generation algorithms that require each projector in a multi-projector system to know what the other projectors are projecting in order to determine the best image to project, and eliminates the need for shared memory by the projectors, which simplifies the implementation hardware. In one embodiment, a separate lookup table 408 is provided for each projector 112, and sub-frame generator 108 applies an appropriate map 406 based on pixel location in the sub-frames 110. In one form of the invention, after the training phase, sub-frame generator 108 is configured to generate each sub-frame 110 in a single pass, non-iterative approach. Sophisticated luminance correction, regularization, supersampling, and other techniques are incorporated into system 100 for “free”, meaning that these techniques are added at no extra run-time computation expense. In one embodiment, system 100 has a fixed run time computation that is independent of the number of added projectors 112, which provides a big advantage for scalability.

One form of the present invention provides an image display system 100 with multiple overlapped low-resolution projectors 112 coupled with an efficient real-time (e.g., video rates) image processing algorithm for generating sub-frames 110. In one embodiment, multiple low-resolution, low-cost projectors 112 are used to produce high resolution images 114 at high lumen levels, but at lower cost than existing high-resolution projection systems, such as a single, high-resolution, high-output projector. One form of the present invention provides a scalable image display system 100 that can provide virtually any desired resolution and brightness by adding any desired number of component projectors 112 to the system 100.

In some existing display systems, multiple low-resolution images are displayed with temporal and sub-pixel spatial offsets to enhance resolution. There are some important differences between these existing systems and embodiments of the present invention. For example, unlike some existing systems where all of the sub-frames go through the same optics and the shifts between sub-frames are all simple translational shifts, in one form of the present invention, the sub-frames 110 are projected through the different optics of the multiple individual projectors 112. In one form of the invention, the signal processing model that is used to generate optimal sub-frames 110 takes into account relative geometric distortion among the component sub-frames 110, and is robust to minor calibration errors and noise.

It can be difficult to accurately align projectors into a desired configuration. In one embodiment of the invention, regardless of what the particular projector configuration is, even if it is not an optimal alignment, sub-frame generator 108 determines and generates optimal sub-frames 110 for that particular configuration.

Algorithms that seek to enhance resolution by offsetting multiple projection elements have been previously proposed. These methods assume simple shift offsets between projectors, use frequency domain analyses, and rely on heuristic methods to compute component sub-frames. In contrast, one form of the present invention utilizes an optimal real-time sub-frame generation algorithm that explicitly accounts for arbitrary relative geometric distortion (not limited to homographies) between the component projectors 112, including distortions that occur due to a target surface 116 that is non-planar or has surface non-uniformities. One form of the present invention generates sub-frames 110 based on a geometric relationship between a hypothetical high-resolution reference projector 118 at any arbitrary location and each of the actual low-resolution projectors 112, which may also be positioned at any arbitrary location.

In one embodiment, image display system 100 is configured to project images 114 that have a three-dimensional (3D) appearance. In 3D image display systems, two images, each with a different polarization, are simultaneously projected by two different projectors. One image corresponds to the left eye, and the other image corresponds to the right eye. Conventional 3D image display systems typically suffer from a lack of brightness. In contrast, with one embodiment of the present invention, a first plurality of the projectors 112 may be used to produce any desired brightness for the first image (e.g., left eye image), and a second plurality of the projectors 112 may be used to produce any desired brightness for the second image (e.g., right eye image). In another embodiment, image display system 100 may be combined or used with other display systems or display techniques, such as tiled displays. For example, for a displayed image 114 with a plurality of tiles, each tile in the displayed image 114 could be produced by a different plurality of overlapping projectors 112, such as a first set of three projectors 112 for producing overlapping sub-frames for a first tile, a second set of three projectors 112 for producing overlapping sub-frames for a second tile, and so on.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method of displaying an image with a display system, the method comprising:
generating a plurality of map values based on at least one training image;
receiving a first image frame;
generating a plurality of sub-frames corresponding to the first image frame based on a geometric relationship between a reference coordinate system and a plurality of projectors, and based on the plurality of map values; and
projecting the plurality of sub-frames onto a target surface with the plurality of projectors, thereby producing a resulting image on the target surface.

2. The method of claim 1, wherein generating the plurality of map values comprises:
generating a plurality of training sub-frames based on the at least one training image;
identifying a plurality of sets of pixels in the at least one training image, each set of pixels corresponding to a pixel in one of the training sub-frames; and
computing a set of map values for each identified set of pixels.

3. The method of claim 2, wherein the plurality of sets of pixels in the at least one training image are identified by geometrically mapping points in the training sub-frames to corresponding points in the at least one training image.

4. The method of claim 3, wherein each of the plurality of sets of pixels in the at least one training image is a window of pixels around a mapped point in the at least one training image.

5. The method of claim 2, wherein the plurality of training sub-frames are generated in an iterative process based on maximization of a probability that a simulated image is the same as the at least one training image, and wherein the simulated image is defined as a summation of up-sampled, filtered, and geometrically transformed training sub-frames.

6. The method of claim 1, wherein the at least one training image comprises at least one white noise image.

7. The method of claim 1, wherein the at least one training image comprises at least one impulse image.

8. The method of claim 1, wherein generating the plurality of sub-frames comprises:
identifying a plurality of sets of pixels in the first image frame, each identified set of pixels corresponding to a pixel in one of the sub-frames;
identifying a plurality of sets of the map values, each identified set of map values corresponding to one of the identified sets of pixels; and
filtering the identified plurality of sets of pixels in the first image frame with the identified plurality of sets of map values, thereby generating sub-frame pixel values for the plurality of sub-frames.

9. The method of claim 8, wherein the plurality of sets of pixels in the first image frame are identified by geometrically mapping points in the plurality of sub-frames to corresponding points in the first image frame.

10. The method of claim 9, wherein each of the plurality of sets of pixels in the first image frame is a window of pixels around a mapped point in the first image frame.

11. The method of claim 1, and further comprising:
storing the plurality of map values in at least one look-up table.

12. The method of claim 11, wherein the at least one look-up table comprises one look-up table for each of the plurality of projectors.

13. The method of claim 11, wherein the at least one look-up table is addressed by positions of pixels in the plurality of sub-frames.

14. A system for displaying an image, the system comprising:
a plurality of projection devices;
a buffer adapted to receive a first image frame;
a sub-frame generator configured to define a plurality of sub-frames corresponding to the first image frame based on a geometric relationship between a reference coordinate system and the plurality of projection devices, and based on a plurality of stored map values that are computed during a training phase of the system; and
wherein the plurality of projection devices are adapted to project the plurality of sub-frames onto a target surface, thereby producing a resulting image on the target surface.

15. The system of claim 14, wherein the plurality of map values are computed by generating a plurality of training sub-frames based on at least one training image, identifying a plurality of sets of pixels in the at least one training image, each set of pixels corresponding to a pixel in one of the training sub-frames, and computing a set of map values for each identified set of pixels.

16. The system of claim 15, wherein the plurality of training sub-frames are generated by the sub-frame generator in an iterative process based on maximization of a probability that a simulated image is the same as the at least one training image.

17. The system of claim 16, wherein the simulated image is defined as a summation of up-sampled, filtered, and geometrically transformed training sub-frames.

18. The system of claim 14, wherein the sub-frame generator is configured to define the plurality of sub-frames by identifying a plurality of sets of pixels in the first image frame, each identified set of pixels corresponding to a pixel in one of the sub-frames, identifying a plurality of sets of the map values, each identified set of map values corresponding to one of the identified sets of pixels, and filtering the identified plurality of sets of pixels in the first image frame with the identified plurality of sets of map values, thereby generating sub-frame pixel values for the plurality of sub-frames.

19. The system of claim 14, and further comprising:
a plurality of look-up tables for storing the map values, wherein each of the look-up tables corresponds to one of the projection devices.

20. A method of generating sub-frames for display by a display system, the method comprising:
receiving a plurality of training images during a training phase of the display system;
generating a plurality of sets of training sub-frames during the training phase, each set of training sub-frames corresponding to one of the training images;
generating a plurality of map values during the training phase based on the plurality of sets of training sub-frames;
receiving a first image frame during a normal operation phase of the display system; and
generating a plurality of sub-frames during the normal operation phase based on the plurality of map values, the plurality of sub-frames corresponding to the first image frame and configured to be projected by a corresponding plurality of projectors to produce a resulting image.
